(19) United States
(12) Patent Application Publication
(10) Pub. No.: US 2016/0094665 A1
(43) Pub. Date: Mar. 31, 2016

(54) Session Handling in a Stateless Communication Environment

(71) Applicants: Jan Kellmereit, Darmstadt (DE); Miguel Lencinas, Speyer (DE)

(72) Inventors: Jan Kellmereit, Darmstadt (DE); Miguel Lencinas, Speyer (DE)

(21) Appl. No.: 14/499,683

(22) Filed: Sep. 29, 2014

(51) Int. Cl. H04L 29/08; H04L 29/06

(52) U.S. Cl. CPC H04L 67/142; H04L 67/42; H04L 67/02

(57) ABSTRACT

An example method includes, receiving a first data request for data transmission between a client and a server; when the first data request does not read data from the server to the client: using a first session to communicate with the server to fulfill the first data request. The first session was in existence before the first data request is received. The method further includes, after fulfilling the first data request, receiving a second data request for data transmission between the client and the server; when the second data request reads data from the server to the client: causing the first session between the client and the server to be closed; and after the first session is closed: causing a second session between the client and the server to be opened; and using the second session to communicate with the server to fulfill the second data request.

### BACKGROUND

Handling communication sessions (e.g., by a client device) in a stateless communication environment (e.g., a stateless protocol) is important: Without requiring a server to memorize client context (e.g., client state), each client request can be handled independently and thus more flexibly.

Difficulties abound, however. One technical problem is that, due to the lack of client context (e.g., stateless) on server side, a client device is expected to properly maintain each communication session and to provide essential context (e.g., parameters) for each client request.

Another technical problem is that, with the increased popularity in mobile computing device (e.g., a smart phone, a smart watch, or a tablet) and mobile applications thereon (e.g., an IPHONE app), a client device may open and maintain many a sessions (e.g., one session per mobile app) with a server, which can result in server performance deterioration.

There is therefore a need for improved techniques to handle sessions in a stateless communication protocol.

### BRIEF DESCRIPTION OF THE DRAWINGS

FIG. 1 is an example block diagram illustrating a computing system for handling sessions in a stateless communication environment, in accordance with some implementations;

FIGS. 2-4 are example flow charts illustrating various methods for handling sessions in a stateless communication environment, in accordance with some implementations; and

FIG. 5 is an example block diagram illustrating an example computing system for handling sessions in a stateless communication environment, in accordance with some implementations.

### DETAILED DESCRIPTION

The implementations described herein provide various technical solutions to improve performance of handling sessions in a stateless communication environment, and in particular to the above-identified technical problems—by (1) maintaining one (e.g., single) session between a client device and a server computer for servicing client requests that do not involve reading data from the server computer to the client device, (e.g., write requests, such as modifying server data); and (2) closing an existing session and opening a new session for servicing read requests (e.g., populating data from a backend database into a web page shown on the client device).

As a non-limiting example, in a stateless communication environment (e.g., where the HTTP is used), when sending a request to a server, a client device first determines whether a session between the client device and the server currently exists. If there is none, the client device opens a new session for communication with the server. This is sometimes called initiating a session.

If, however, there is an existing session, the client device then proceeds to determine whether the client request involves reading data from the server to the client (e.g., a read request) or not (e.g., a write request).

Next, if the client request includes a read request (and there is an existing session), the client device closes the existing session and opens a new session—rather than reusing the existing session—for servicing the client request. This is, for example, to ensure that data integrity, e.g., prior write operations have been properly applied before server data are read to the client.

If, however, the client request does not include a read request (e.g., a request to update a server table), the client device reuses the existing session—rather than terminating the existing session and opening another session anew—for servicing the client request. This is, for example, to reduce overhead associated with opening and closing sessions.

By these ways, the amount of resources often required for maintaining multiple client-server sessions can be lessened and the freed up resources made available for other resource-intensive tasks. This is particularly important for applications running on mobile devices (e.g., a smart phone, a smart watch, or a tablet computing) where resources are more limited, compared to non-mobile devices, such as a desktop computer.

Data integrity is also ensured: read requests are serviced using brand new client-server sessions and with necessary parameters, without requiring a server to memorize (e.g., store) client context—an important requirement in a stateless communication environment.

Additional details of implementations are now described in relation to the figures.

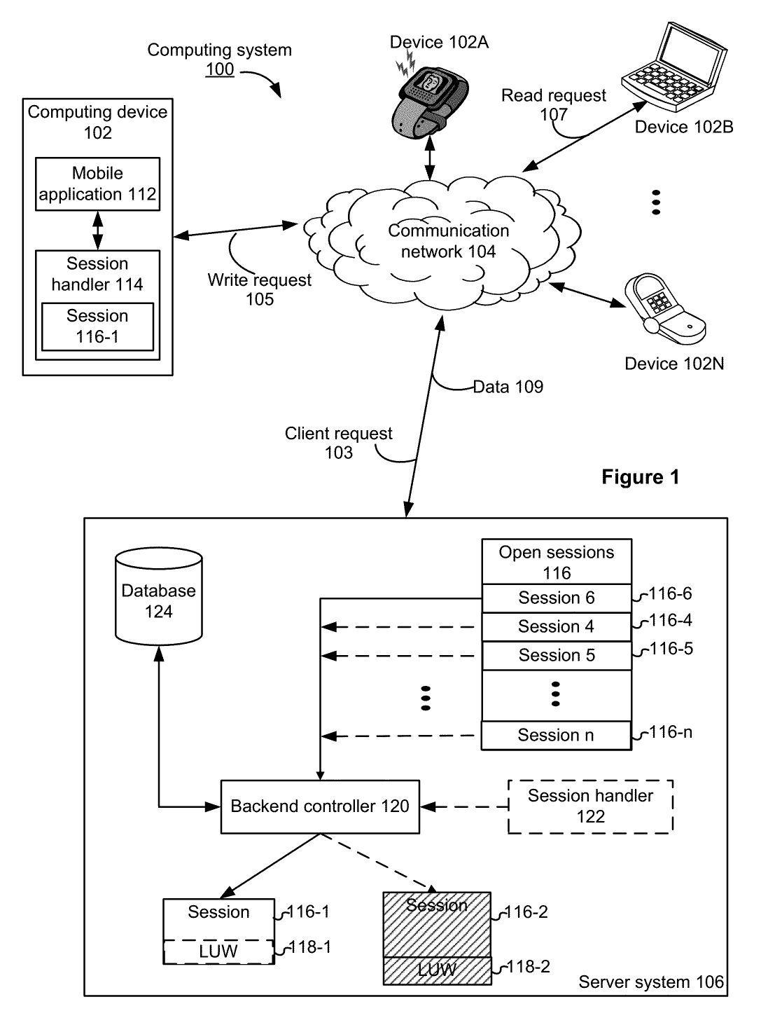

FIG. 1 is an example block diagram illustrating a computing system for handling sessions in a stateless communication environment, in accordance with some implementations.

In some implementations, the computing system 100 includes one or more computing devices 102 (e.g., 102-A, 102-B, . . . , and 102-N), a communication network 104, and a server system 106.

In some implementations, a computing device 102 enables a user to interact with one or more mobile applications resident thereon, which in turn communicate with corresponding server applications or access data stored on the server system 106. In some implementations, the computing device 102 obtains user selection within a mobile application, and communicates them to the server system 106, by way of sending client requests 103 (e.g., a write request 105 or a read request 107) to the server 106. For example, a user may, using a mobile app, enter travel itineraries and scan hotel receipts to request reimbursement for these costs.

In some implementations, the computing device 102 is a mobile computing device, such as a laptop computer, a notebook computer, a smart phone, or a tablet computer. In some implementations, a computing device 102 is a (e.g., light weight) client device (also referred to herein as client 102).

In some implementations, a computing device 102 hosts one or more mobile applications 112, and a session handler 116 (e.g., a software component) for managing sessions between the computing device 102 and the server 106. In some implementations, a mobile application is an APPLE IPONE application (or app) or a GOOGLE ANDROID app. In some implementations, the session handler 116 (e.g., a software component) manages sessions between the computing device 102 and the server 106, e.g., opening a new session, closing an existing session, and using an existing session.

In some implementations, the communication network 104 interconnects one or more computing devices 102 with each other, and with the server system 106. In some implementations, the communication network 104 optionally includes the Internet, one or more local area networks (LANs), one or more wide area networks (WANs), other types of networks, or a combination of such networks.

In some implementations, the server system 106 (also referred to herein as server 106) manages communications (e.g., sessions) with one or more computing devices 102, e.g., updating server data in accordance with a write request or providing data responsive to read request.

In some implementations, the server 106 is a computing cloud that processes requests from a plurality of mobile computing devices (or mobile clients) 102. In some implementations, the server 106 hosts one or more server applications, such as: an enterprise data processing application, an enterprise travel planning and expense reimbursement application, an enterprise resource planning (ERP) application, an enterprise data management (EDM) application, or an enterprise feedback management (EFM).

In some implementations, the server 106 includes a backend controller 120, optionally a session handler 122 (similar to the session 114 on the client 102), and a database 124.

In some implementations, the backend controller 120 manages (e.g., allocates and de-allocates) one or more logical units of work (LUWs) on the server 106 for responding to client requests 103, e.g., writing data to the database 124 in accordance with the write request 105, or reading data from the database 124 in accordance with the read request 107 and transmitting the data to the device 102A.

In some implementations, the backend controller 120 also manages one or more open (e.g., existing) sessions 116 (e.g., 116-4, 116-5, 116-6, . . . , 116-n) for communication with clients 102. For example, responsive to the write request 105, the backend controller 120 (via the session 116-1 with the device 102) receives data 109 from the device 102 and updates the database 124 (through an assigned LUW) in accordance therewith; For another example, responsive to the read request 107, the backend controller 120 first closes an existing session 116-2 (shown in FIG. 1 in shades) and opens a new session with the device 102-B, in order to read data from the database 124 to the device 120B. Closing an existing session and opening a new session for responding to a read request is advantageous: First, the client 102 (and the server 106) needs only to maintain one single session (rather than multiple session, e.g., one for reading data and another writing data), thereby conserving system (e.g., network and computing) resource, as each session may need its own dedicated resource (e.g., network bandwidth and CPU time) for client-server communication; Second, in cases where a stateless (as opposed to stateful) communication protocol is used for communication between a client 102 and the server 106, opening a new session for read requests ensures that correct (e.g., most recent) data are retrieved, because data (or files) opened in an existing session may have been updated (e.g., in the database 124) by another service or application, and thus data read (e.g., retrieved) using an existing session may not reflect these (e.g., recent) updates.

In some implementations, the session handler 122 manages sessions with one or more client devices 102, e.g., opening a new session, closing an existing session, and using an existing session. In some implementations, the session handler 122 also manages LUWs associated with one or more sessions, e.g., allocating a LUW for a new session, maintaining a LUW for an existing session, and with one or more client devices 102, closing a LUW for a closed session.

In some implementations, the database 124 manages and stores data on the server 106 in accordance with client requests 103, e.g., updating server data in accordance with a write request or providing data responsive to read request. In some implementations, the database 124 stores and manages enterprise data, which include business data, such as sales/business expenses/revenues, customer profiles, and supplier profiles. In some implementations, the database24 includes one or more databases, for example, a MICROSOFT SQL Server database, an Oracle database, or a SYBASE database.

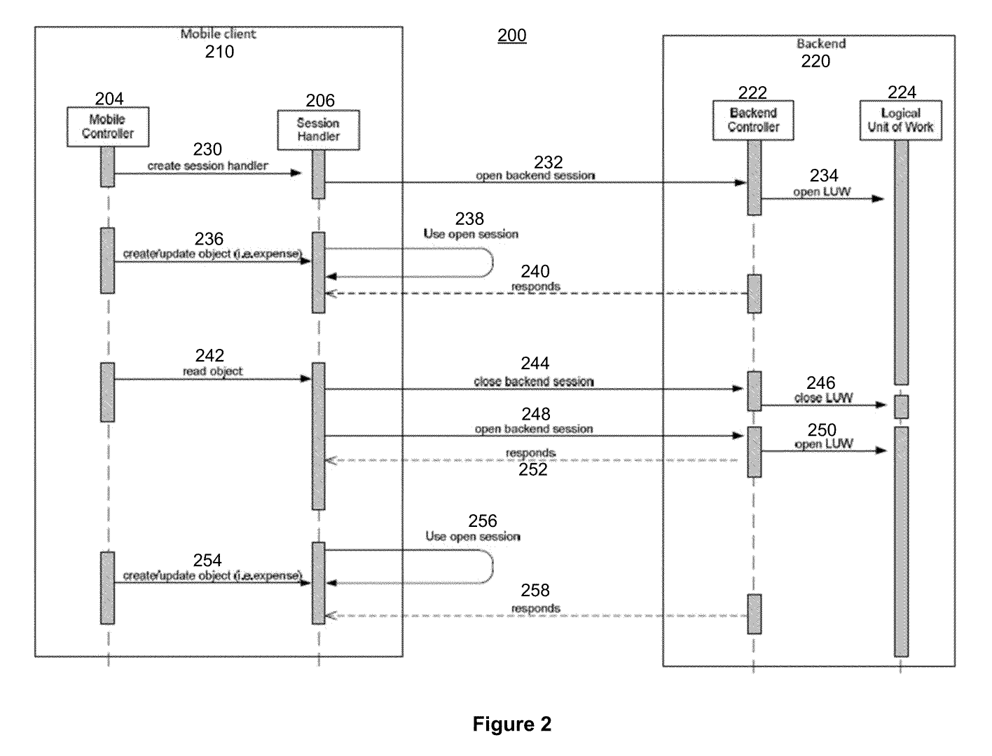

FIG. 2 is an example flow chart illustrating a method 200 for handling sessions in a stateless communication environment, in accordance with some implementations.

As shown in FIG. 2, in some implementations, a computing device 102 is a mobile client 210, such as a smart phone or a tablet computer. In some implementations, the mobile client 210 hosts a mobile controller 201 and a session handler 206 (e.g., similar to or the same as the session handler 114 shown in FIG. 1.

As also shown in FIG. 2, in some implementations, the server system 106 is called the backend 220, which hosts a backend controller 222 and maintains one or more logical unites of work (LUWs) 224.

In some implementations, when a session controller 206 (or an instant thereof) has not been created, the mobile client 210 creates (230) a session handler, which manages communication session between the mobile client 210 and the backend 220.

In some implementations, when there is no existing session between the mobile client 210 and the backend 220, the session handler 206 opens (232) a new session for servicing requests by the mobile client 210 to the backend 220. In some implementations, after a session is opened, the backend controller 222 opens a LUW for servicing client requests communicated using the session.

In some implementations, when a non-read request (e.g., a client request that does not involve reading data—excluding de minimis communication, such as handshake acknowledgements—from the backend 220 to the client 210) is received, the session handlers 206 uses an existing session, e.g., the session opened in step 232, and the backend 220 responds (240) using the same session. In some implementations, the non-read request is a request to create or update (236) a data object in a server database.

In some implementations, when a read request (e.g., a client request that involve reading data from the backend 220 to the client 210) is received, the session handlers 206 closes (244) the (e.g., only) existing session, which in some cases includes closing (246) the LUW assigned to the session, thereby releasing server resource that may no longer be necessary. In some implementations, the read request is a request in a series of requests, e.g., write request 1, write request 2, read request 3, write request 4, and write request 5. In some implementations, a series of request is considered, as a whole, a read request, as long as there is at least one read request in the series of requests.

In some implementations, to service the read request, however, the session handler 206 opens (248) a new backend session, which in turn causes a new LUW to be opened (250) and assigned to the session. In some implementations, after the new session is created, the backend 220 responds (e.g., services) (252) the read request 242 using the new session.

In some implementations, after the servicing the read request (242), the mobile client 210 uses (or reuses) (256) the session created in step 248 to service subsequent read requests (e.g., a request to create or update a data object 254).

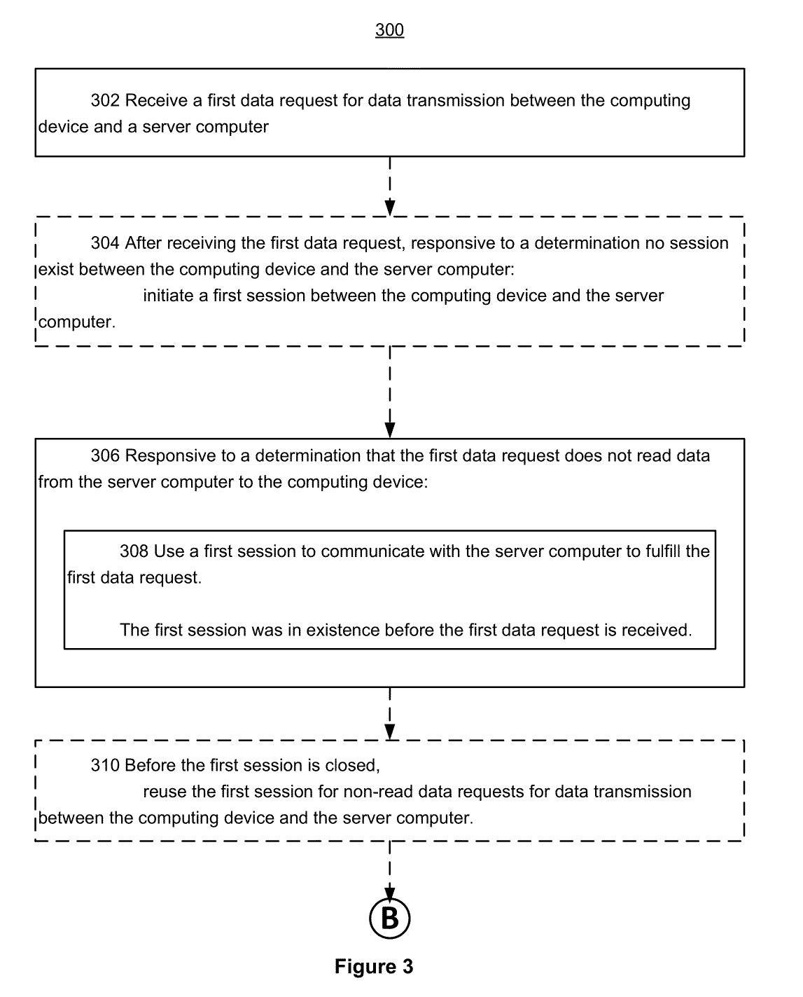

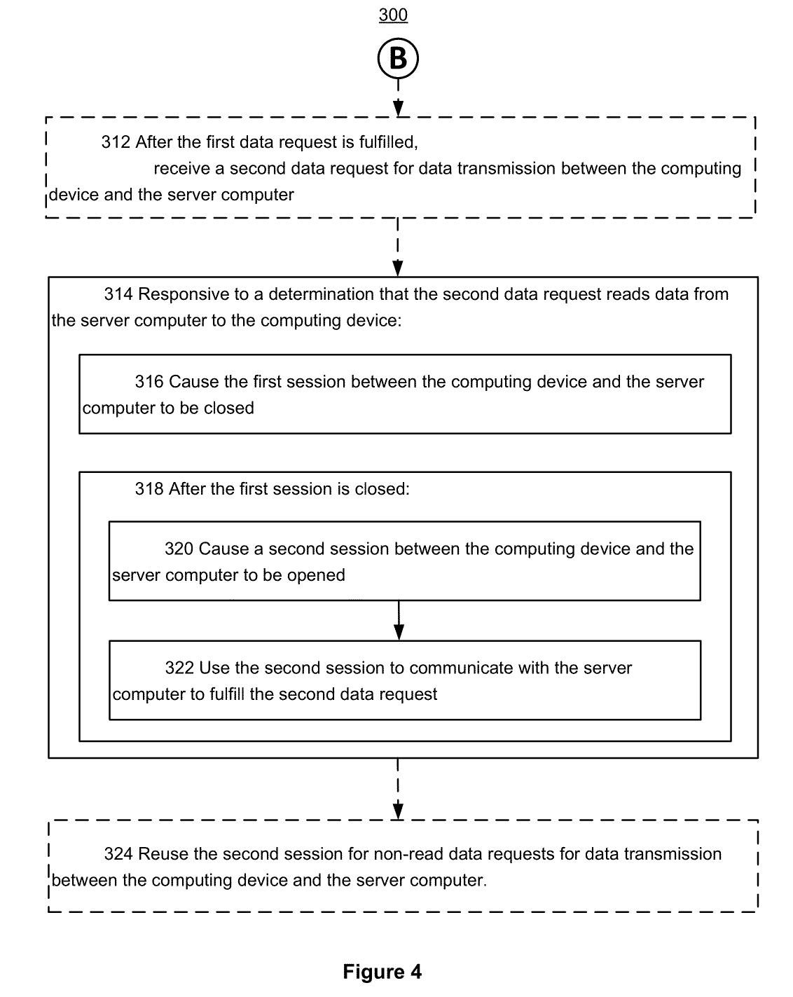

FIGS. 3-4 are example flow charts illustrating a method 300 for handling sessions in a stateless communication environment, in accordance with some implementations.

In some implementations, the method 300 is implemented at a computing device 102, e.g., a client device. In some implementations, the computing device 102 is equipped with one or more processors and memory storing one or more programs for execution by the one or more processors. In other implementations, the method 300 is implemented at a server system 106, e.g., a computer that is equipped with one or more processors and memory storing one or more programs for execution by the one or more processors.

In some implementations, the method 300 includes: receiving (302) a first data request for data transmission between the computing device and a server computer.

In some implementations, the method 300 further includes: after receiving the first data request, responsive to a determination no session exist between the computing device and the server computer: initiating a first session between the computing device and the server computer. For example, after receiving a request (e.g., to write data to the server database 124), if a client device 102 determines that there is no existing session between the client device and the server 106 (for fulfilling this request), the client device 102 (via the session handler 114) opens a new session. In some implementations, opening a new session includes, creating the session handler 114 (optional), opening a backend session between the client device and the server 106 (via the session handler 114 and the backend controller 120, on the client device and the server, respectively), and opening a LUW (via the backend controller 120), as shown by the steps 230, 232, and 234 in FIG. 2.

In some implementations, after receiving the first data request, the client 102, responsive to a determination (304) that no session exist between the computing device and the server computer, initiates a first session between the computing device and the server computer. In some implementations, when there is no current (or existing) session between a client and a server, the client initiates a new session in order to service a client request.

In some implementations, responsive to a determination (306) that the first data request does not read data from the server computer to the computing device: the computing device uses (308) a first session to communicate with the server computer to fulfill the first data request. In some implementations, the first session was in existence before the first data request is received. For example, the first session was opened before the first data request was received.

In some implementations, the method 300 further includes: before the first session is closed, reusing (310) the first session for non-read data requests for data transmission between the computing device and the server computer. For example, in some case, once the first session is established, the client device can continue to use the first session to fulfill subsequent client requests that do not involve reading data from the server. This is advantageous, as overhead associated with termination an existing session and initiating a new session is reduced.

In some implementations, after the first data request is fulfilled, the client receives (312) a second data request for data transmission between the computing device and the server computer. For example, after servicing a write request, a client receives another write request.

In some implementations, responsive to a determination (314) that the second data request reads data from the server computer to the computing device: causing (316) the first session between the computing device and the server computer to be closed. For example, upon determining (e.g., using parameters within a client request) that the second request involves reading data from a server to a client (e.g., populating a spreadsheet displayed on a smart phone using data stored in a server database), the client, using the session handler 116-1, closes the existing session between the client and the server.

In some implementations, after the first session is closed (318), the method 300 causes (320) a second session between the computing device and the server computer to be opened; and uses (322) the second session to communicate with the server computer to fulfill the second data request. For example, after closing an existing session, the client opens a new session in order to read data from the server to the client.

In some implementations, the method 300 further includes: maintaining only one single session between the computing device and the server computer. For example, in some case, only a single communication session between a client device and a server is allowed, e.g.., in order to keep resume consumption low (both for the client as the server), because maintaining multiple open sessions consumes more system resource (e.g., computing time and network bandwidth).

In some implementations, maintaining only one single session with the server computer includes: before opening a new session between the server computer and the computing device, causing an existing session between the server computer and the computing device to be closed. For example, the before servicing a read request, the session handler 116-1 checks whether there is an existing session between the client and the server.

And if there is an existing session, the session handler closes the existing session and opens a new session, e.g., so as to keep only a single session between the client and the server.

In some implementations, the method 300 further includes: reusing (324) the second session for non-read data requests for data transmission between the computing device and the server computer. For example, after the second session is established and the second (e.g., read) request is fulfilled (e.g., or serviced), the second session is not disconnected (or closed); instead, the client maintains the second session for subsequent non-read requests (e.g., write requests, such as a request to modify server data, a request to delete a row from a database). This is advantageous, as a write request can be fulfilled successfully without all prior write requests to be apply to the same server data. For example, the client 102A changes (request 1) value of the first row and the first column of the database 124 to “123”; and subsequently (e.g., later in time), the client 102B changes (request 2) that same value (in the first row and the first column of the database 124) to “456.” In this case, the request 1 needs not be applied first, before the request 2 is applied (although to ensure data integrity the request 1 may need to be disregarded by the server if request 2 is applied first).

In some implementations, the method 300 is implemented in a stateless communication protocol, such as the Internet Protocol (IP), or the Hypertext Transfer Protocol (HTTP), which is used in web- or cloud-based mobile applications.

In some implementations, a stateless protocol is a communications protocol that treats each request as an independent transaction unrelated to any previous request so that the communication consists of independent pairs of request and response. In some implementations, the stateless protocol does not require the server to retain session information or status about each communications partner for the duration of multiple requests. This is contrasted with a stateful protocol (e.g., the File Transfer Protocol, (FTP)), a protocol that requires keeping of the internal state on a server.

In some implementations, using a stateless communication protocol is advantageous: there is no need to dynamically allocate storage to deal with conversations in progress. If a client device dies (e.g., due to a request cancellation, a malfunction, or a power outage) in mid-transaction, there is no need (for either the client device or a server) to be responsible for cleaning up the present state of the server.

In some implementations, the stateless communication protocol is the HTTP protocol, and the first data request and the second data request are HTTP requests. For example, in some cases, the mobile applications 112 (shown in FIG. 1) are web- or cloud-based applications (e.g., the SAP Travel OnDemand application); and the client requests 103 (shown in FIG. 1) are HTTP requests.

In some implementations, the method 300 is executed in accordance with a determination that an amount of available computing resource associated with the server computer is below a predefined threshold amount. In some implementations, the method 300 is executed upon a trigger event that the server computer is experiencing a resource shortage, e.g., when CPU time is occupied by other devices, when memory usage is very high, when data transmission has significantly slowed down, or when a large number of (e.g., 1000) devices have connected with the server. These techniques are advantageous: it may be beneficial to refrain from opening additional sessions (e.g., by maintaining a single session) when server resource is already low, because establishing additional session is likely to exacerbate the situation (e.g., even more lengthy response time from the server).

In some implementations, the method 300 is executed in accordance with a determination that a total number of sessions open on the server computer is above a predefined threshold number. In other implementations, the method 300 is executed upon a trigger event that the server computer has a large number of pending open sessions with one or more other mobile devices, which often precedes (and thus can be predicative of) a performance dip in the near future. These techniques are advantageous: it may be beneficial to refrain from opening additional sessions (e.g., by maintaining a single session) when it is likely that any additional session may significantly cause server performance to drop (e.g., causing the server to hang).

In some implementations, the method 300 further includes: responsive to a determination that no data requests for data transmission between the computing device and the server computer is received within a predefined time period, causing the second session to be closed. For example, an existing session may time out (e.g., remains idle for a predefined length of time) and thus be closed, e.g., in order to recycle session resource, on both the server side and the client side.

In some implementations, the first data request and the second data request are JavaScript Object Notation (JSON) calls. For example, in some cases, data communications between the mobile applications 112 and the server applications are implemented using JSON format. In other cases, data communications between the mobile applications 112 and the server applications are implemented using XML format.

In some implementations, the firs data request updates data on the server computer, and the second request updates data on the computing device. For example, the first data request transmits client data (e.g., travel expenses a user has entered) to the server and updates the server database 124 (e.g., a datable for storing corporate expense) using these client data.

In some implementations, the first data request is an update or create commend, and the second data request is a read commend. For example, the first client request updates a row in a server database o creates a new row in the server database; the second client request reads the first row from a server database and display data stored therein on a web page, for review by a user.

In some implementations, the computing device is a mobile computing device, and the first data request and the second data request are issued by a mobile application resident on the mobile computing device. For example, the device 102 is a mobile device, such as a smart phone, a smart watch, a tablet, or a laptop; and the data request are issued by a mobile application (e.g., an IPHONE app or a GOOGLE ANDROID app) on the mobile device.

In some implementations, the server computer is a computing cloud, e.g., an SAP HANA cloud, an AMAZON Web Services cloud, an Oracle cloud, or an IBM cloud.

In some implementations, the server computer is an enterprise data processing server, e.g., an SAP ERP application server or an SAP travel expense reimbursement application.

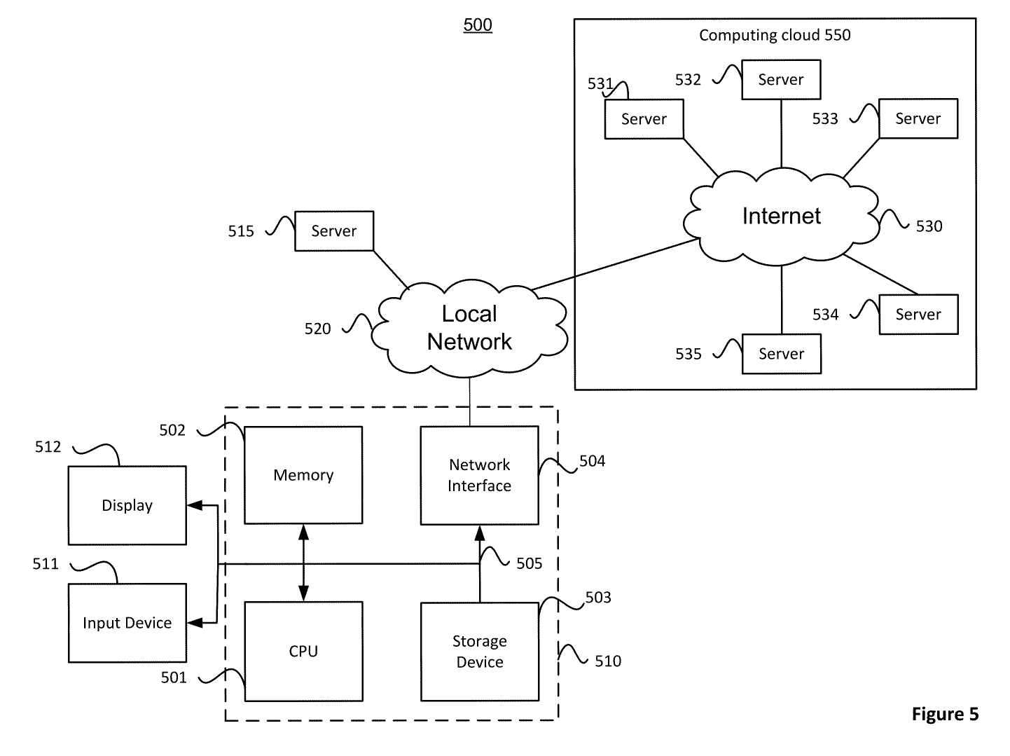

FIG. 5 is an example block diagram illustrating an example computing system 500 for handling sessions in a stateless communication environment, in accordance with some implementations

As shown in FIG. 5, in some implementations, the computing system 510 includes a bus 505 or other communication mechanism for communicating information, and a processor 501 coupled with the bus 505 for processing information. In some implementations, the computing system 510 also includes a memory 502 coupled to bus 505 for storing information and instructions to be executed by processor 501, including information and instructions for performing the techniques described above, for example. In some implementations, the memory 502 may also be used for storing variables or other intermediate information during execution of instructions to be executed by processor 501. In some implementations, the memory 502 includes, but is not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computing system can obtain information. In some implementations, the storage device 503 may include source code, binary code, or software files for performing the techniques above, for example. The storage device 503 and the memory 502 are both examples of computer readable mediums.

In some implementations, the computing system 510 may be coupled via the bus 505 to a display 512, such as a cathode ray tube (CRT) or liquid crystal display (LCD), for displaying information to a user. An input device 511 such as a keyboard and/or mouse is coupled to the bus 505 for communicating information and command selections from the user to the processor 501. The combination of these components allows the user to communicate with the computing system 510. In some systems, the bus 505 may be divided into multiple specialized buses.

In some implementations, the computing system 510 includes a network interface 504 coupled with the bus 505. In some implementations, the network interface 504 provides two-way data communications between the computing system 510 and the local network 520. In some implementations, the network interface 504 includes a digital subscriber line (DSL) or a modem to provide data communication connection over a telephone line, for example. Another example of the network interface 504 is a local area network (LAN) card to provide a data communication connection to a compatible LAN. Wireless links are another example. In any such implementation, the network interface 504 sends and receives electrical, electromagnetic, or optical signals that carry digital data streams representing various types of information.

In some implementations, the computing system 510 sends and receives information, including messages or other interface actions, through the network interface 504 across a local network 520, an Intranet, or the Internet 530. In some implementations, the local network, the computing system 510 communicates with a plurality of other computer machines, such as a server 515or a computing cloud 550. In some implementations, the computing system 510 and server computer systems represented by the server 515 form a cloud computing network, which may be programmed with processes described herein. In the Internet example, software components or services may reside on multiple different computing systems 510 or servers 531-535 across the network. In some implementations, the processes described above are implemented at computing cloud 550, which includes one or more servers from the servers 531-535. In some implementations, the server 531 transmits actions or messages from one component, through the Internet 530, the local network 520, and the network interface 504 to a component of the computing system 510. In some implementations, the software components and processes described above are implemented on any computer system and send and/or receive information across a network.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first session could be termed a second session, and, similarly, a second session could be termed a first session, without changing the meaning of the description, so long as all occurrences of the “first session” are renamed consistently and all occurrences of the “second session” are renamed consistently. The first session and the second session are both sessions, but they are not the session.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed.

Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method comprising:
at a computing device having one or more processors and memory storing one or more programs for execution by the one or more processors:
receiving a first data request for data transmission between the computing device and a server computer;
responsive to a determination that the first data request does not read data from the server computer to the computing device:
using a first session to communicate with the server computer to fulfill the first data request, wherein the first session was in existence before the first data request is received;
after the first data request is fulfilled,
receiving a second data request for data transmission between the computing device and the server computer;
responsive to a determination that the second data request reads data from the server computer to the computing device:
causing the first session between the computing device and the server computer to be closed; and
after the first session is closed:
causing a second session between the computing device and the server computer to be opened; and
using the second session to communicate with the server computer to fulfill the second data request.

2. The method of claim 1 is implemented in a stateless communication protocol.

3. The method of claim 2, wherein the stateless communication protocol is the HTTP protocol, and the first data request and the second data request are HTTP requests.

4. The method of claim 1, further comprising: maintaining only one single session between the computing device and the server computer.

5. The method of claim 4, wherein maintaining only one single session with the server computer includes:
before opening a new session between the server computer and the computing device,
causing an existing session between the server computer and the computing device to be closed.

6. The method of claim 1, further comprising: reusing the second session for non-read data requests for data transmission between the computing device and the server computer.

7. The method of claim 1, further comprising:
before the first session is closed,
reusing the first session for non-read data requests for data transmission between the computing device and the server computer.

8. The method of claim 1, further comprising:
after receiving the first data request,
responsive to a determination no session exist between the computing device and the server computer:
initiating the first session between the computing device and the server computer.

9. The method of claim 1 is executed in accordance with a determination that an amount of available computing resource associated with the server computer is below a predefined threshold amount.

10. The method of claim 1 is executed in accordance with a determination that a total number of sessions open on the server computer is above a predefined threshold number.

11. The method of claim 1, further comprising: responsive to a determination that no data requests for data transmission between the computing device and the server computer is received within a predefined time period, causing the second session to be closed.

12. The method of claim 1, wherein the first data request and the second data request are JSON calls.

13. The method of claim 1, wherein the firs data request updates data on the server computer, and the second request updates data on the computing device.

14. The method of claim 13, wherein the first data request is an update or create commend.

15. The method of claim 13, wherein the second data request is a read commend.

16. The method of claim 1, wherein the computing device is a mobile computing device, and the first data request and the second data request are issued by a mobile application resident on the mobile computing device.

17. The method of claim 13, wherein the server computer is a computing cloud.

18. The method of claim 1, wherein the server computer is an enterprise data processing server.

19. A non-transitory computer readable storage medium storing one or more programs, the one or more programs comprising instructions, which when executed by a computing system with one or more processors, cause the computing system to execute a method of:
receiving a first data request for data transmission between the computing device and a server computer;
responsive to a determination that the first data request does not read data from the server computer to the computing device:
using a first session to communicate with the server computer to fulfill the first data request, wherein the first session was in existence before the first data request is received;
after the first data request is fulfilled,
receiving a second data request for data transmission between the computing device and the server computer;
responsive to a determination that the second data request reads data from the server computer to the computing device:
causing the first session between the computing device and the server computer to be closed; and
after the first session is closed:
causing a second session between the computing device and the server computer to be opened; and
using the second session to communicate with the server computer to fulfill the second data request.

20. A computing system, comprising:
one or more processors;
memory; and
one or more programs, wherein the one or more programs are stored in the memory and configured to be executed by the one or more processors, the one or more programs including instructions for:
receiving a first data request for data transmission between the computing device and a server computer;
responsive to a determination that the first data request does not read data from the server computer to the computing device:
using a first session to communicate with the server computer to fulfill the first data request, wherein the first session was in existence before the first data request is received;
after the first data request is fulfilled,
receiving a second data request for data transmission between the computing device and the server computer;
responsive to a determination that the second data request reads data from the server computer to the computing device:
causing the first session between the computing device and the server computer to be closed; and
after the first session is closed:
causing a second session between the computing device and the server computer to be opened; and
using the second session to communicate with the server computer to fulfill the second data request.
